(19) United States
(12) Patent Application Publication
(10) Pub. No.: US 2022/0120041 A1
(43) Pub. Date: Apr. 21, 2022

(54) Battery-Operated Spike Driver

(71) Applicant: Focused Technology Solutions, Inc., Hackettstown, NJ (US)

(72) Inventors: Peter M. BARTEK, Ledgewood, NJ (US); Miroslaw BOGDANOWICZ, Hillsborough Township, NJ (US); Corey DASH, Mount Arlington, NJ (US); Paul OOSTDYK, Hopatcong, NJ (US)

(73) Assignee: Focused Technology Solutions, Inc., Hackettstown, NJ (US)

(21) Appl. No.: 17/502,920

(22) Filed: Oct. 15, 2021

Related U.S. Application Data
(60) Provisional application No. 63/092,317, filed on Oct. 15, 2020.

(51) Int. Cl. E01B 29/26; B25D 11/00

(52) U.S. Cl. CPC E01B 29/26; B25F 5/00; B25D 11/00

(57) ABSTRACT

A battery-operated tool is disclosed for use in the rail industry. In some embodiments, the battery-operated tool may comprise a battery-operated spike driver configured to drive in spikes configured to hold rails for a railway onto a fixed point. The battery-operated tool may include or otherwise be connected to a battery management system. The battery management system may be configured to manage the power supplied to the battery-operated device via one or more batteries. In various embodiments, the one or more batteries may comprise a set of rechargeable batteries connected in series or in parallel. In some embodiments, the battery management system may be attached to or included within the battery-operated device. In other embodiments, the battery management system may be physically separate from the battery-operated device. For example, the battery management system may be included within a separate battery pack that includes the set of batteries.

### RELATED APPLICATIONS

This application claims priority to U.S. Provisional Patent Application No. 63/092,317, filed Oct. 15, 2020, the content of which is incorporated herein by reference in its entirety.

### FIELD OF THE INVENTION

The present invention relates to the rail industry, and, more particularly, to a battery-operated tool for use in the rail industry.

### BACKGROUND OF THE INVENTION

Currently, there are no battery-operated spike drivers for the rail industry that provide adequate power for sustained use. There are also no tool configurations for the rail industry that enable a cordless battery-operated tool to be converted into a corded tool capable of performing tasks with a much higher power requirement, and vice versa. There is a need for a single tool capable of performing tasks requiring varying degrees of power without sacrificing the mobility provided by a tool powered using small rechargeable batteries. There is also a need for a system configured to safeguard the normal operation of a tool when utilizing a series of small rechargeable batteries connected in parallel or in series.

### SUMMARY OF THE INVENTION

Aspects of this disclosure relate to a battery-operated tool (or device) for use in the rail industry. In various embodiments, the battery-operated tool may comprise a battery-operated spike driver configured to drive in spikes configured to hold rails for a railway onto a fixed point. In other embodiments, the battery-operated tool may comprise a battery-operated spike puller, a battery-operated tamper tool, a battery-operated packing tool, and/or one or more other types of tools that are battery-operated and configured for use in the rail industry. For example, in some embodiments, the battery-operated tool may be configured to receive one or more attachments that enable the tool to be one or more types of tools.

In various embodiments, the battery-operated tool may include or otherwise be connected to a battery management system. The battery management system may be configured to manage the power supplied to the battery-operated device via one or more batteries. In various embodiments, the one or more batteries may comprise a set of rechargeable batteries connected in series or in parallel. For example, the one or more batteries may comprise a set of 6 or 7 rechargeable batteries connected in series or in parallel. In some embodiments, the battery management system may be configured to cause the set of rechargeable batteries to run down one at a time. In some embodiments, the battery management system may be configured to automatically shut down the battery-operated device if a controller temperature exceeds a threshold temperature. In some embodiments, the battery management system may comprise an active battery equalization system configured to automatically shut off and disable one or more batteries when low voltage is detected. In some embodiments, the battery management system may be attached to or included within the battery-operated device. In other embodiments, the battery management system may be physically separate from the battery-operated device. For example, the battery management system may be included within a separate battery pack comprising the set of batteries and connected to the battery-operated device via a cord. In some embodiments, this separate battery pack may be located within a rolling device configured to move with the battery-operated device as the battery-operated device moves along the rails of a railway.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a front view of an example embodiment of a battery-operated spike driver, according to one or more aspects described herein;

FIG. 2A and FIG. 2B depict a tamper attachment for a battery-operated tool for use in the rail industry, according to one or more aspects described herein;

FIG. 3 depicts a packing attachment for a battery-operated tool for use in the rail industry, according to one or more aspects described herein;

FIG. 4A depicts an example battery management system for a battery-operated tool for use in the rail industry that is powered by batteries connected in parallel, according to one or more aspects described herein; and

FIG. 4B depicts an example battery management system for a battery-operated tool for use in the rail industry that is powered by batteries connected in series, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION OF THE INVENTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three dimensional orientation of structures in order to fall within the scope of this invention.

The invention described herein relates to a battery-operated tool (or device) 100 for use in the rail industry. In various embodiments, battery-operated tool 100 may include a spike driver component 110, a power source 120, a handle 130, and/or one or more other components which may all be connected to a main body 140 of battery-operated tool 100. In various embodiments, battery-operated tool 100 may include or otherwise be connected to a battery management system 400. In some implementations, battery management system 400 may be attached to or physically included within battery-operated tool 100. In other implementations, battery management system 400 may be physically independent from battery-operated tool 100. For example, battery management system 400 may be located within a remote power source comprising a set of batteries that is connected to battery-operated tool 100 via a cord.

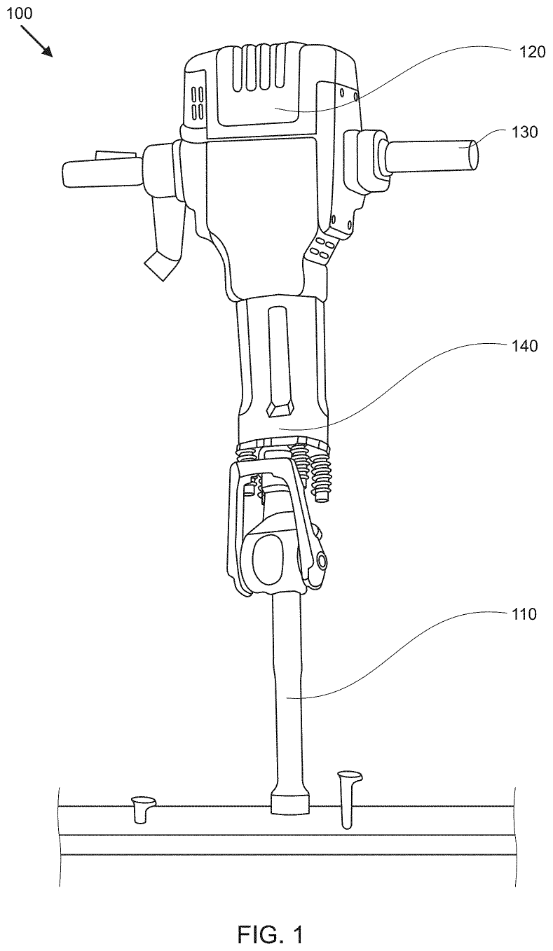

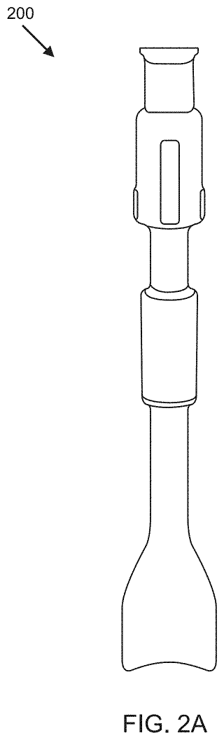

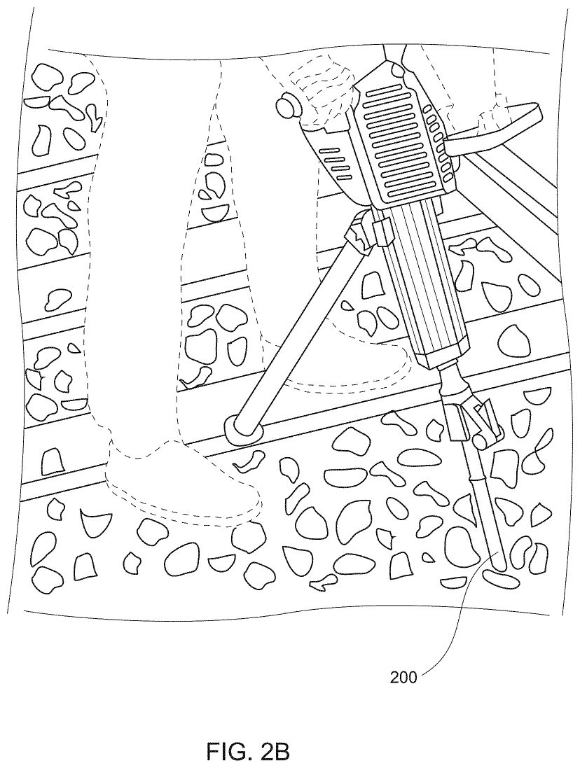

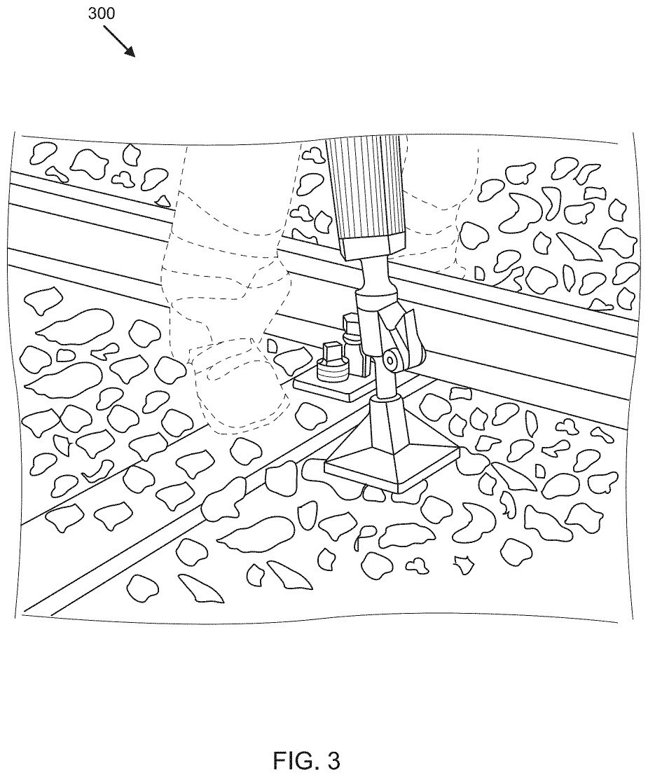

In various embodiments, battery-operated tool 100 may comprise a battery-operated spike driver as depicted in FIG. 1. For example, battery-operated tool 100 may comprise a battery operated spike driver configured to drive in spikes or other components specifically configured to hold rails for a railway onto a fixed point. In other embodiments, battery-operated tool 100 may comprise a battery-operated spike puller, a battery-operated tamper tool, a battery-operated packing tool, and/or one or more other types of tools that are battery-operated and configured for use in the rail industry. For example, in some embodiments, battery-operated tool 100 may be configured to receive one or more attachments that enable the tool to be one or more types of tools. The one or more attachments may include a spike puller attachment configured to remove a railroad spike from a rail tie; a tamper attachment configured to tamp down the ground, debris, or railway components within a railyard; a packing attachment configured to pack the ground underneath or proximate a railway; and/or one or more other attachments. In such embodiments, spike driver component 110 may itself comprise a removable attachment that may be replaced with one or more other attachments. For example, battery-operated tool 100 may be configured to receive a tamper attachment 200 as depicted in FIGS. 2A-2B, a packing attachment 300 as depicted in FIG. 3, and/or one or more other attachments configured to enable the tool to be used as one or more other types of tools. In some implementations, battery-operated tool 100 may include a safety emergency switch that is configured to power down battery-operated tool 100 when activated by an operator. In some implementations, battery-operated tool 100 and/or other components described herein (e.g., a separate power source) may be configured to operate with LED light banks and any 120 V direct current device or motors with a commutator.

In some implementations, battery-operated tool 100 may include one or more quick connect/disconnect components and/or a single push-button quick-release system for quickly swapping in and out different attachments. For example, using one or more quick connect/disconnect components and/or a single push-button quick-release system, battery-operated tool 100 may allow an operator to remove one attachment (e.g., the spike driver component) and replace it with another attachment (e.g., a tamper attachment, a packing attachment, and/or one or more other attachments). In some implementations, battery-operated tool 100 may include one or more quick connect/disconnect components and/or a single push-button quick-release system as described in U.S. patent application Ser. No. 17/100,649, entitled “TIE DRILL AND LAG SCREW INSERTER DEVICE FOR THE RAIL INDUSTRY,” or U.S. patent application Ser. No. 17/342,979, entitled “TIE DRILL AND LAG SCREW INSERTER DEVICE FOR THE RAIL INDUSTRY,” the disclosures of which are each hereby incorporated by reference in their entirety herein.

According to an aspect of the invention, battery-operated tool 100 may include or be connected to battery management system 400. In various implementations, battery management system 400 may be configured to manage the power supplied to a battery-operated tool via one or more AC batteries and/or one or more DC batteries. In an example embodiment, battery management system 400 may be configured to control a 120 V AC commutator motor using DC voltage. In various embodiments, the battery-management system may include an active battery equalization system, a microprocessor data collecting system, and/or one or more other components.

The active battery equalization system may include a smart automatic shut and disable function. For example, the active battery equalization system may be configured to automatically shut off and disable the function of one or more batteries when low voltage is detected. In various embodiments, the active battery equalization system may comprise a single series battery chip machine controlling circuit and/or one or more other components.

The microprocessor data collecting system may include a monomer battery voltage collecting unit and/or one or more other components. In various embodiments, the monomer battery voltage collecting unit may include an integrated operational amplifier circuit and/or digital simulation switches. In various embodiments, the microprocessor data collecting system may be configured to connect to the active equalization system via the single chip machine controlling circuit.

In various embodiments, battery management system 400 may be configured to facilitate the safe utilization of a set of batteries (AC or DC). For example, battery management system 400 may be configured to cause a set of batteries to be run down one at a time.

In various embodiments, battery management system 400 may be configured to automatically shut down if controller temperature gets too high. In other words, if a temperature threshold is exceeded, the system may be configured to automatically shut down. For example, microprocessor data collecting system may be configured to determine or acquire a temperature for the system (or controller) and compare the temperature to a predefined temperature threshold. Responsive to a determination that the temperature exceeds the predefined temperature threshold, microprocessor data collecting system may be configured to communicate with active battery equalization system to automatically shut down and disable the system.

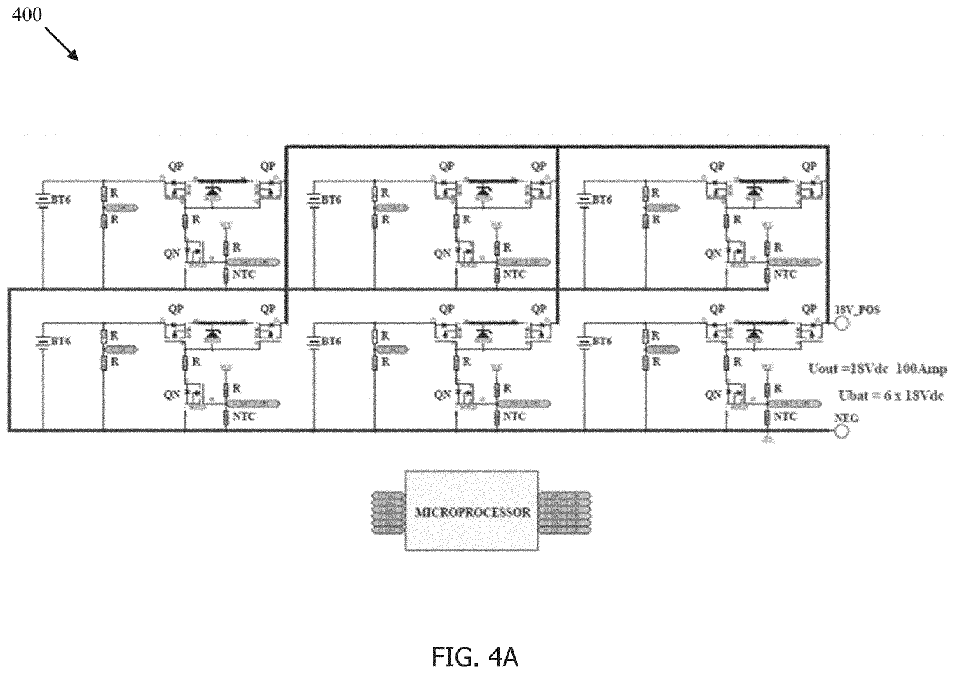

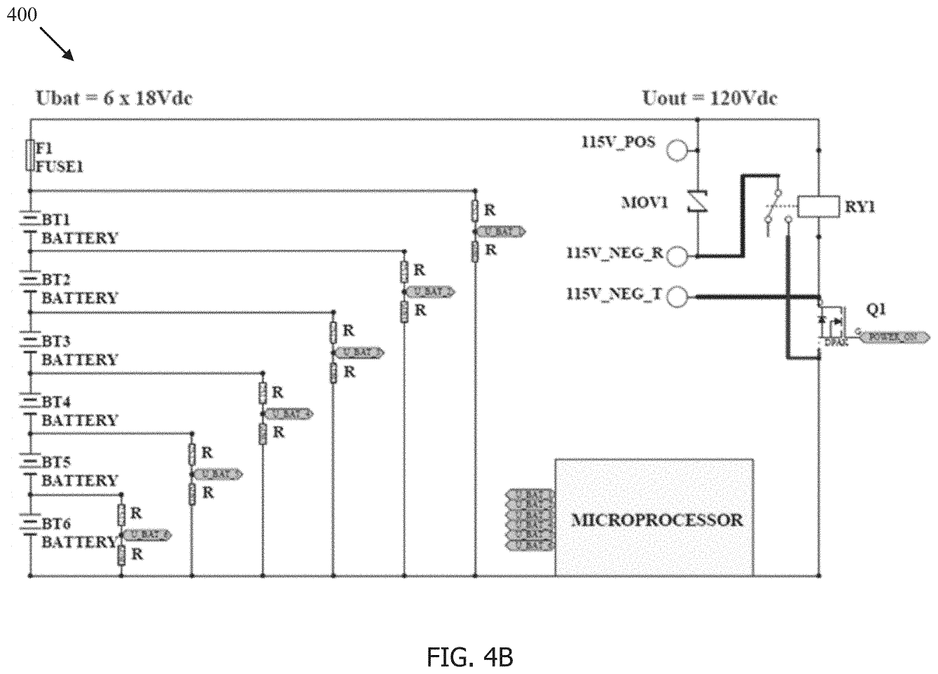

In some embodiments, battery management system 400 may be utilized in a tool for the rail industry that is powered via a set of batteries connected in parallel. For example, FIG. 4A depicts a battery management system 400 for a tool powered by batteries connected in parallel, according to one or more aspects described herein. The set of batteries used to power the tool may comprise two or more batteries connected in parallel. In some implementations, the set of batteries used to power the tool may comprise, for example, six or seven batteries connected in parallel. For example, as depicted in FIG. 4A, the set of batteries used to power the tool may comprise six batteries connected in parallel with an output power of 18 Vdc/100 Amp. In various embodiments, a microprocessor (e.g., of the microprocessor data collecting system) may be configured to monitor the battery voltage of all the batteries within the set of batteries. In the example battery configuration depicted in FIG. 4A, power to output load may be enabled if at least three batteries have enough voltage.

In some embodiments, battery management system 400 may be utilized in a tool for the rail industry that is powered via a set of batteries connected in series. For example, FIG. 4B depicts a battery management system 400 for a tool powered by batteries connected in series, according to one or more aspects described herein. The set of batteries used to power the tool may comprise two or more batteries connected in series. In some implementations, the set of batteries used to power the tool may comprise, for example, six or seven batteries connected in series. For example, as depicted in FIG. 4B, the set of batteries used to power the tool may comprise six batteries connected in series with an output power of 120 Vdc/100 Amp. In various embodiments, a microprocessor (e.g., of the microprocessor data collecting system) may be configured to monitor the battery voltage of all the batteries within the set of batteries. In the example battery configuration depicted in FIG. 4B, power to output load may be disabled if any of the six batteries is discharged.

In some embodiments, battery-operated tool 100 may be configured to use one or more battery packs for any AC tool that provides, for example, at least 110 V. The use of these battery pack may provide hours worth of operation if while operating an AC tool. In other embodiments, a battery pack that utilizes battery management system 400 for DC described herein may be utilized.

In an example embodiment, battery-operated tool 100 may be tethered to another device comprising a set of batteries. For example, battery-operated tool 100 may be tethered to a device comprising a set of batteries arranged in parallel (as depicted in FIG. 4A) or in series (as depicted in FIG. 4B). In some embodiments, at least one battery pack may be physically attached to battery-operated tool 100 and used to connect battery-operated tool 100 to the separate device comprising the set of batteries.

In some embodiments, the power source (e.g., the battery or set of batteries utilized to power battery-operated tool 100) may be located within or physically attached to the tool. In other words, the power source may be a component of battery-operated tool 100. In some embodiments, the power source (e.g., the battery or set of batteries utilized to power battery-operated tool 100) may be external to or physically separate from the tool. For example, the power source may be connected via cord to battery-operated tool 100. In implementations in which the power source is external to or physically separate from the tool, the power source may be included within a separate device that also includes a battery management system the same as or similar to batter management system 400 described herein. In embodiments in which the power source is external to the tool and connected via a cord, a roller device may be provided that is configured support and provide mobility to the power source such that the power source may move with the tool as the tool is used along the rails. In some embodiments, the roller device may be configured to ride on one side of the rail. For example, the roller device may be comprise a top roller, a bottom anti-lift roller, side guide rollers, and/or one or more other components configured to enable the roller device to ride on one side of the rail.

In other implementations, battery-operated tool 100 may include a replaceable and removable drill with a handle. For example, the replaceable and removable drill may comprise an impact drill, driver, wrench, or similar tool, such as electronic, pneumatic, or other such drill-type tool. In some implementations, the replaceable and removable drill may include a rechargeable battery configured to provide power to battery-operated tool 100. For example, battery-operated tool 100 may include, and be powered by, a replaceable and removable drill as described in U.S. patent application Ser. No. 15/175,900, entitled “RAIL SPIKE REMOVER,” or U.S. patent application Ser. No. 16/734,125, entitled “RAIL SPIKE REMOVER,” the disclosures of which are each hereby incorporated by reference in their entirety herein.

The present disclosure is disclosed above and in the accompanying drawings with reference to a variety of examples. The purpose served by the disclosure, however, is to provide examples of the various features and concepts related to the disclosure, not to limit the scope of the invention. It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. Specifically, it should be understood that the components or features of one embodiment described herein may be combined to with one or more components or features of other embodiments described herein without departing from the scope of the invention. The embodiments described herein explain the best modes known for practicing the invention and will enable others skilled in the art to utilize the invention.

While the preferred embodiments of the invention have been shown and described, one skilled in the relevant art will recognize that numerous variations and modifications may be made to the examples described above without departing from the scope of the present disclosure. Thus, the spirit and scope of the invention should be construed broadly as set forth in the appended claims.

What is claimed is:

1. A battery-operated device for use in the rail industry, the device comprising:
a main body comprising a handle at one end;
a spike driver component attached to the main body at an end opposite the handle, wherein the spike driver component is configured to drive in a railroad spike that holds a rail for a railway onto a fixed point; and
a battery management system configured to manage power supplied to the battery-operated device via one or more batteries.

2. The battery-operated device of claim 1, wherein the spike driver component comprises a removable attachment, and wherein the battery-operated device is configured to receive one or more other attachments.

3. The battery-operated device of claim 2, wherein the one or more other attachments comprise a spike puller attachment configured to remove a railroad spike from a rail tie, a packing attachment configured to pack ground underneath or proximate a railway, and/or a tamper attachment configured to tamp down ground, debris, or railway components within a railyard.

4. The battery-operated device of claim 1, wherein the one or more batteries comprise a set of rechargeable batteries.

5. The battery-operated device of claim 4, wherein the battery management system comprises an active battery equalization system configured to automatically shut off and disable one or more batteries of the set of rechargeable batteries when low voltage is detected.

6. The battery-operated device of claim 4, wherein the battery management system is configured to cause the set of rechargeable batteries to run down one at a time.

7. The battery-operated device of claim 1, wherein the one or more batteries comprise a set of batteries connected in series.

8. The battery-operated device of claim 1, wherein the one or more batteries comprise a set of batteries connected in parallel.

9. The battery-operated device of claim 1, wherein the battery management system is configured to automatically shut down the battery-operated device if a controller temperature exceeds a threshold temperature.

10. The battery-operated device of claim 1, wherein the battery management system is attached to or included within the battery-operated device.

11. The battery-operated device of claim 1, wherein the battery management system is physically separate from the battery-operated device.

12. The battery-operated device of claim 1, wherein the one or more batteries comprise a set of batteries located within a separate battery pack connected to the battery-operated device via a cord.

13. The battery-operated device of claim 12, wherein the battery management system is included within the separate battery pack.

14. The battery-operated device of claim 12, wherein the separate battery pack is located within a rolling device configured to move with the battery-operated device as the battery-operated device moves along rails of a railway.
